(19) United States
(12) Patent Application Publication
(10) Pub. No.: US 2019/0244403 A1
(43) Pub. Date: Aug. 8, 2019

(54) PAINT REFLECTION AROUND A CURVILINEAR PATH

(71) Applicant: Adobe Inc., San Jose, CA (US)

(72) Inventors: Walter Michael Shaw, Fremont, CA (US); Michael Clifton, Scotts Valley, CA (US)

(73) Assignee: Adobe Inc., San Jose, CA (US)

(21) Appl. No.: 15/891,891

(22) Filed: Feb. 8, 2018

(51) Int. Cl. G06T 11/40; G06T 11/00; G06T 11/80

(52) U.S. Cl. CPC G06T 11/40; G06T 11/80; G06T 11/001

(57) ABSTRACT

Techniques for creating a mirror symmetric image using a curvilinear or non-linear axis of symmetry (symmetry axis) in 2-D or 3-D space. For each of a set of sample points defining an image, a respective tangent line associated with a sample point is determined with respect to the curvilinear axis of symmetry. A linear paint reflection operation is then performed with respect to the current sample point and the respective tangent line to generate a respective symmetry point. The operation is performed for each sample point such that an aggregate reflection is performed for all sample points to generate a reflected image around the curvilinear path.

### FIELD OF THE DISCLOSURE

This disclosure relates to techniques for computer graphics and digital drawing and painting. In particular, this disclosure relates to techniques providing reflection symmetry around a curvilinear path in a drawing context.

### BACKGROUND

In digital drawing and painting (and even using traditional methods), it is often desirable for an artist to use symmetry to create a design. For example, drawing a human or animal face or the front of a car as well as all kinds of abstract geometric objects involve symmetry. The most common type of symmetry in this kind of artistic creation is “vertical symmetry” where the left and right halves of an image are mirrored copies of one another. In traditional painting and drawing, symmetry may be accomplished by using tools like a mirror or tracing or carbon paper. Digital painting tools can make this process much easier and quicker for the artist. Although some painting/drawing digital tools provide for generating mirror symmetric drawings in a linear context, there are other more creative applications of mirror symmetry that would be valuable in digital drawing/painting tools. For example, there are several reasons why performing mirror symmetry using a non-linear axis of symmetry is desirable. First, perfect symmetry across a linear axis does not exist in most of the macroscopic natural world. That is, perfect symmetry is for the most part not lifelike and typically there exists some degree of asymmetry in natural objects, although the asymmetry may be subtle. Thus, in order to render an asymmetric representation, typically a symmetric representation may first be generated and then the symmetric representation may be modified to introduce some asymmetry. For example, minor inflections may be introduced along a path so they appear asymmetrical. Second, in general, it is desirable to allow for a symmetry definition around paths that are not straight lines. Although known techniques exist for performing mirror symmetry around a linear axis, a need exists for performing a symmetry operation on a non-linear (i.e., curvilinear) axis of symmetry.

### BRIEF DESCRIPTION OF THE DRAWINGS

FIG. 1a is a flowchart of a process for performing paint reflection around a curvilinear path in an interactive mode according to an embodiment of the present disclosure.

FIG. 1b is a flowchart of a process for performing paint reflection around a curvilinear path in a batch mode according to another embodiment of the present disclosure.

FIG. 2 depicts a curvilinear symmetry path in relation to computation of reflected paint coordinates according to an embodiment of the present disclosure.

FIG. 3 depicts a structure and operation of a curvilinear paint reflection module according to an embodiment of the present disclosure.

FIG. 4 shows an example of paint reflection around a linear path according to an embodiment of the present disclosure.

FIG. 5a shows an example of paint reflection using a curvilinear path according to an embodiment of the present disclosure.

FIG. 5b shows an example of paint reflection using a circular curvilinear path according to another embodiment of the present disclosure.

FIG. 6a illustrates an example computing system that executes a curvilinear paint reflection module according to an embodiment of the present disclosure.

FIG. 6b illustrates an example integration of a curvilinear paint reflection module into a network environment according to another embodiment of the present disclosure.

### DETAILED DESCRIPTION

The present disclosure describes techniques for creating a mirror symmetric image using a curvilinear path or non-linear axis of symmetry in 2-D or 3-D space. For each of a set of sample points comprising an image, a respective tangent line associated with the sample point is computed with respect to the curvilinear axis of symmetry. A linear reflection operation is then performed with respect to the current sample point and the respective tangent line to generate a reflected symmetry point. The operation is performed for each sample point, such that a corresponding tangent line is determined with respect to the curvilinear symmetry axis for each point and a linear reflection is then performed with respect to the sample point and the computed tangent line. As will be appreciated in light of this disclosure, numerous artistic and design applications can benefit from the various techniques disclosed herein for performing a symmetry operation across a non-linear axis of symmetry.

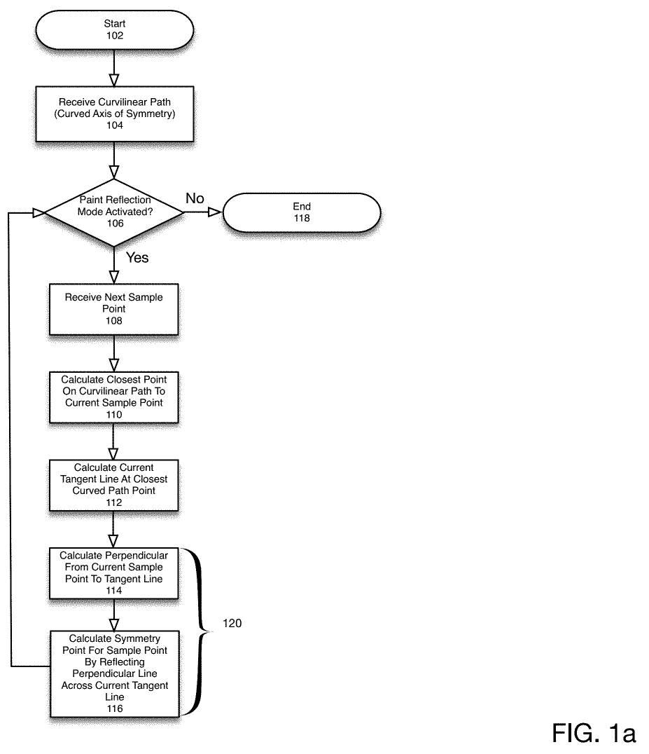

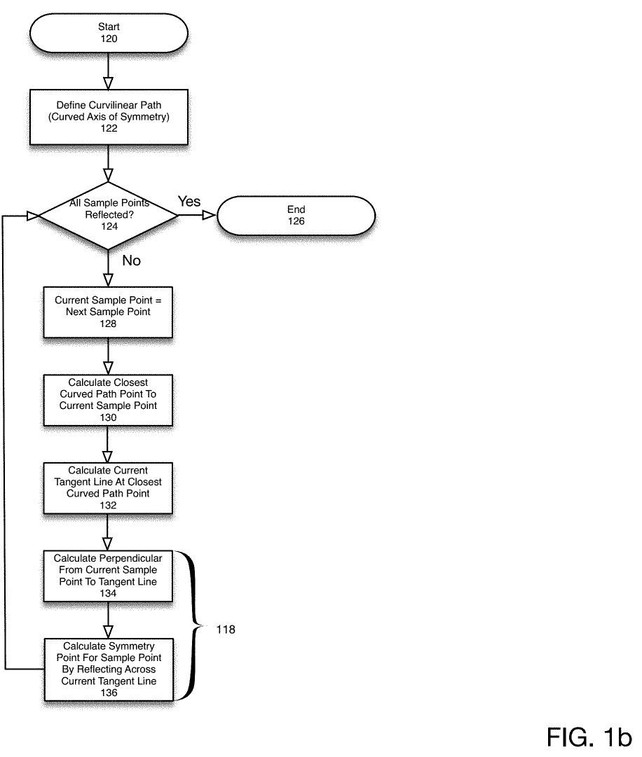

FIG. 1a is a flowchart of a process for performing paint reflection around a curvilinear path in an interactive mode according to one embodiment of the present disclosure. It will be appreciated that the process shown in FIG. 1a may be invoked upon receiving a user input to enter a paint reflection mode, for example, when a user interacts with an electronic drawing program and selects such a mode by clicking, for example, on a button. For purposes of the present discussion, it will be assumed that a sequential stream of sample points comprising an image to be reflected is provided or otherwise made available for processing as described with respect to FIG. 1a. For example, according to one embodiment of the present disclosure, the process shown in FIG. 1a may be made available in an electronic drawing tool that may be controlled via an input device such as a pen or mouse. For example, according to one embodiment of the present disclosure, a user may manipulate an input device such as a mouse or pen such that the user may perform an on-screen drawing process. The on-screen drawing process may emit a time series of sample points corresponding to the drawing position. The sample points defining the image may then be reflected around a curvilinear axis as will now be described with respect to FIG. 1a.

Referring to FIG. 1a, the process is initiated in 102. According to one embodiment of the present disclosure, a user of a drawing tool may define a curvilinear path by drawing such a path using a digital input device such as a mouse or pen. The curvilinear path may comprise a contour comprising a set of discrete points defining the path in 2-D space. The defined curvilinear path may be detected and may thereafter operate as a symmetry axis for performing reflection in an interactive painting mode. In 104, the curvilinear path is received that operates as the axis of symmetry. In 106, it is determined whether a paint reflection mode is activated (i.e., currently active). If not (‘No’ branch of 106), the process ends in 118.

If so (‘Yes’ branch of 106), flow continues with 108 and the next sample point is received. In 110, the closest point to the current sample point on the curvilinear path is computed. According to one embodiment of the present disclosure, a distance metric such as the Euclidean distance may be used to calculate the closest point on the curvilinear path. For example, a distance may be computed between each point on the curvilinear path and the current sample point and the point having the minimum distance metric may then be selected. In 112, a tangent line is computed at the previously determined closest point on the curvilinear path. According to one embodiment of the present disclosure, the tangent line may be computed by calculating the discrete derivative at the closest point on the curvilinear path. An analytic method for computing the tangent line at a point is described below.

Once the associated tangent line is determined, a paint reflection operation around a linear axis of symmetry may be performed. Thus, as shown in FIG. 1a, the steps shown in 118 comprise a method for performing paint reflection around a linear axis of symmetry. In particular, in 114, a representation of a perpendicular line is determined from the current sample point to the closest point on the tangent line determined in 112. In, 116 a reflected symmetry point associated with the current sample point is determined by reflecting the perpendicular line computed in 114 about the tangent line. Flow then continues with 106 where it is determined whether the paint reflection mode is still currently active.

FIG. 1b is a flowchart of a process for performing paint reflection around a curvilinear path in a batch mode according to one embodiment of the present disclosure. It will be appreciated that the process shown in FIG. 1b may be invoked upon receiving a user input to perform a paint reflection process upon a set of sample points that have already been drawn, for example, when a user interacts with an electronic drawing program and selects a batch operation, for example, by clicking on a button. For purposes of the present discussion, it will be assumed that previously drawn set of sample points is provided or otherwise made available to the process depicted in FIG. 1b, for example via an electronic drawing tool that may be controlled via an input device such as a pen or mouse.

Referring to FIG. 1b, the process is initiated in 120. According to one embodiment of the present disclosure, a user of a drawing tool may define a curvilinear path by drawing such a path using a digital input device such as a mouse or pen. The curvilinear path may comprise a contour comprising a set of discrete points defining the path in 2-D space. The defined curvilinear path may be detected and may thereafter operate as a curvilinear path for performing reflection in an interactive painting mode. In 122, the curvilinear path is received that operates as a curvilinear axis of symmetry. In 124, it is determined whether all sample points have been reflected. If so (‘Yes’ branch of 124), the process ends in 126.

If not (‘No’ branch of 124), flow continues with 128 and the current sample point is set to the next sample point. In 128, the closest point to the current sample point on the curvilinear path is computed. According to one embodiment of the present disclosure, a distance metric such as the Euclidean distance may be used to calculate the closest point on the curvilinear path. For example, a distance may be computed between each point on the curvilinear path and the current sample point and the point having the minimum distance metric may then be selected. In 130, the closest point on the curved path to the current sample point is determined. In 132, a tangent line is computed at the closest point on the curvilinear path determined in 130. According to one embodiment of the present disclosure, the tangent line may be computed by calculating the discrete derivative at the closest point on the curvilinear path. An analytic method for computing the tangent line at a point is described below.

The steps shown in 118 comprise a method for performing paint reflection around a linear path. In particular, in 134, a representation of a perpendicular line is determined from the current sample point to the closest point on the tangent line determined in 132. In, 136 a reflected symmetry point associated with the current sample point is determined by reflecting the perpendicular line computed in 134 about the tangent line. Flow then continues with 124 such that it is determined whether all sample points have been reflected.

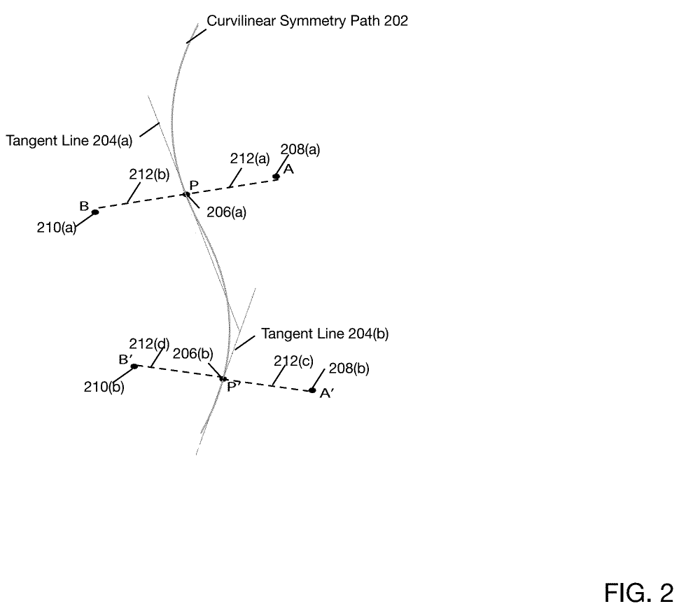

FIG. 2 depicts a curvilinear symmetry path in relation to computation of reflected symmetry point coordinates according to one embodiment of the present disclosure. As shown in FIG. 2 curvilinear symmetry path 202 may be utilized as a symmetry axis to perform paint reflection. Sample points A 208(a) and A′ 208(b) comprise points on an image drawn by a user. Point P 206(a) on curvilinear symmetry path 202 is calculated as the closest point to sample point A 208(a) lying on curvilinear symmetry path 202. Tangent line 204(a) may be computed through point P. Perpendicular AP 212(a) may then be computed with respect to sample point A 208(a) and tangent line 204(a). Perpendicular AP 212(a) may then be reflected around point P 206(a) and tangent line 204(a) to generate reflected perpendicular 212(b) and reflected symmetry point 210(a).

Similarly point P′ 206(b) on curvilinear symmetry path 202 is calculated as the closest point to sample point A′ 208(b) lying on curvilinear symmetry path 202. Tangent line 204(b) may be computed through point P′ 206(b). Perpendicular A′P′ 212(c) may then be computed with respect to sample point A′ 208(b) and tangent line 204(b). Perpendicular A′P′ 212(c) may then be reflected around point P′ 206(b) and tangent line 204(b) to generate reflected perpendicular 212(d) and reflected symmetry point 210(b).

As shown in FIG. 2, curvilinear symmetry path 202 must be finite in length. According to one embodiment of the present disclosure, curvilinear symmetry path 202 may be extended to infinity by concatenating a straight line to each endpoint of curvilinear symmetry path 202, wherein each straight line has a slope associated with a nearby point to the respective endpoints of curvilinear symmetry path 202.

An example method for computing a reflected point with respect to a sample point will now be described. For purposes of the present discussion, the vector to the sample point (e.g., 208(a), 208(b)) is referred to as \vec{s}. According to one embodiment of the present disclosure, for a sample point the closest point on curvilinear symmetry path 202 and its associated vector (herein referred to as p and \vec{p} respectively) may be computed by scanning through all points on curvilinear symmetry path 202 and computing the Euclidean distance to the sample point and then selecting the point on curvilinear symmetry path 202 having the smallest Euclidean distance.

The slope at the determined closest point on curvilinear symmetry path 202 may then be calculated by computing the discrete derivative as follows:

$$m = \frac{n {2}_{y} - n {1}_{y}}{n {2}_{x} - n {1}_{x}}$$

where n2 and n1 are neighboring points to the computed closest point and nₓ and n_{y} respectively are the x and y coordinates of neighboring points. The tangent vector may be expressed as.

$$\vec{t} = \frac{n {2}_{y} - n {1}_{y}}{n {2}_{x} - n {1}_{x}} \hat{t}$$

where \hat{t} is the unit vector in the tangential direction.

The symmetry point may now be computed by first computing the vector \vec{v}, which comprises the vector from the sample point to the closest point p such that:

\vec{v}ₚ=\vec{v}−\vec{v}(\vec{v}·\vec{t})

Then, the reflected symmetry point is:

\vec{s′}=\vec{s}−2\vec{v}ₚ

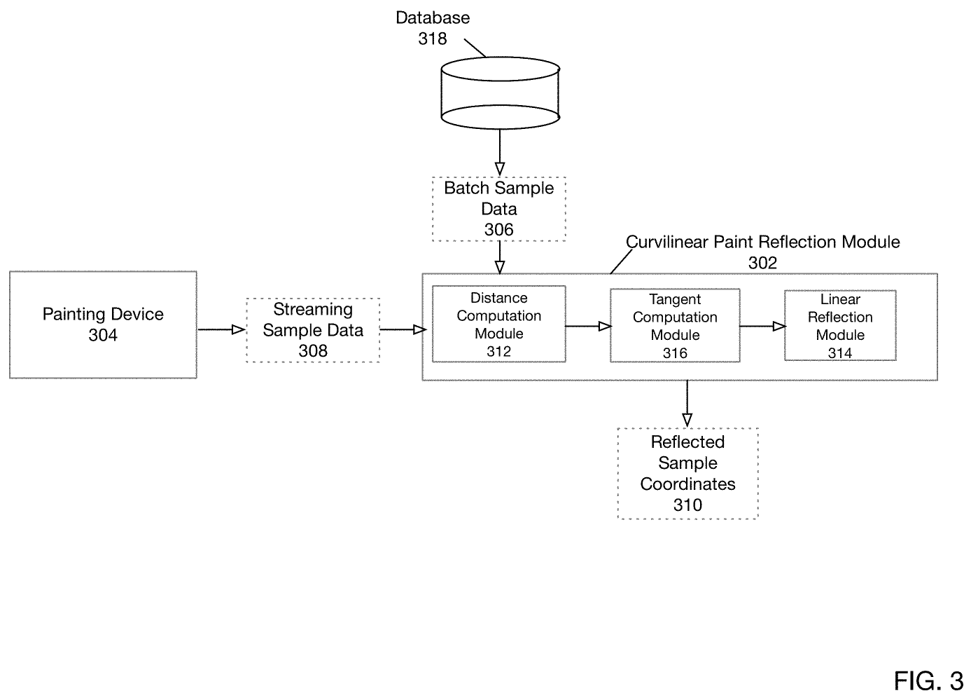

FIG. 3 depicts a structure and operation of a curvilinear paint reflection module according to one embodiment of the present disclosure. As shown in FIG. 3, painting device 304 may generate streaming sample data 308, which is then provided to curvilinear paint reflection module 302. Painting device 304 may be a digital input device such as a mouse or digital pen by which a user of curvilinear paint reflection module 302 may invoke a curvilinear paint reflection process. Sample data may comprise paint coordinates of an image for example in a 2-D or 3-D coordinate system, for example. Streaming sample data 308 may comprise samples of paint coordinates that are generated in real-time, for example in a streaming mode for example when a user interacts with a mouse, digital pen or other input device.

Batch sample data 306 may comprise samples that have been previously stored, for example in database 318. That is, batch sample data 306 may have been generated and stored in database 318 by a user interacting with a digital painting program/process, for example using painting device 318.

Curvilinear paint reflection module 302 may utilize either streaming sample data 308 or batch sample data 306 to generate reflected sample coordinates 310. A method for computing reflected sample coordinates has been described above. As shown in FIG. 3, curvilinear paint reflection module 302 may further comprise distance computation module 312, tangent computation module 316 and linear reflection module 314. Distance computation module 312 may perform computations to determine the closest point on a curvilinear path 202 to a sample point on an image to be reflected. Tangent computation module 316 may generate a representation of a tangent line at a particular point on a curvilinear path. Linear reflection module 314 may operate upon a sample point and a tangent line to generate a reflected sample point. In particular, linear reflection module 314 may receive the coordinates of a sample point on an image and operate to generate the reflected sample point coordinates for the point reflected around the tangent line to the closest point to the sample point on the curvilinear path.

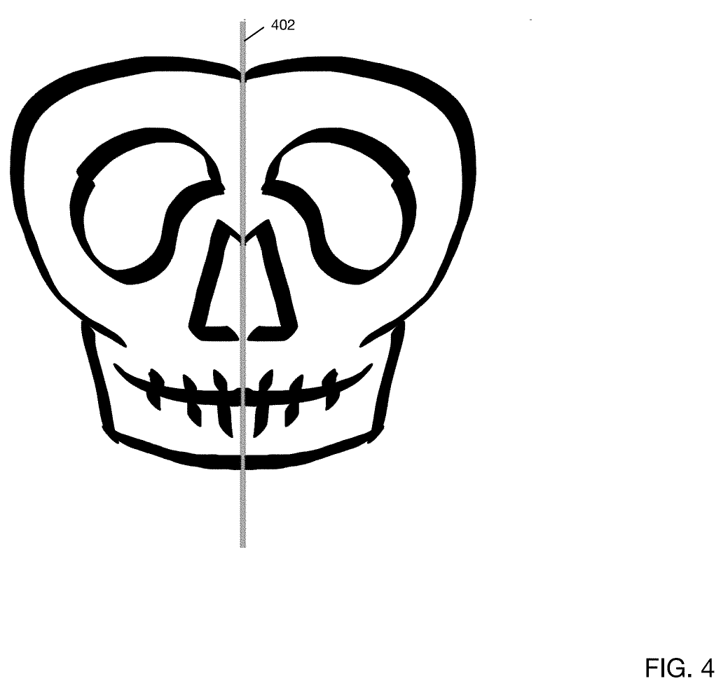

FIG. 4 shows an example of paint reflection around a linear path according to one embodiment of the present disclosure.

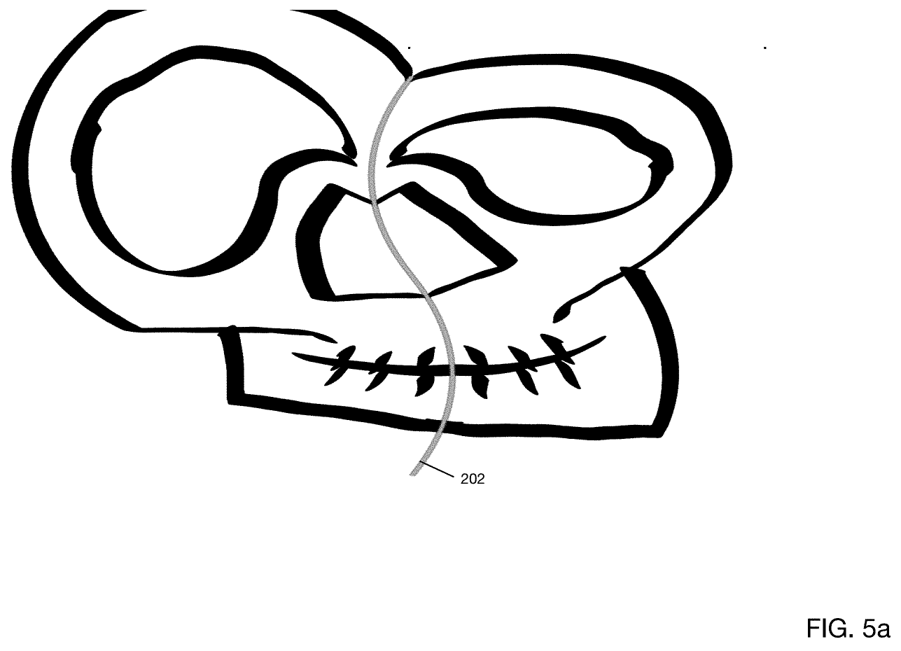

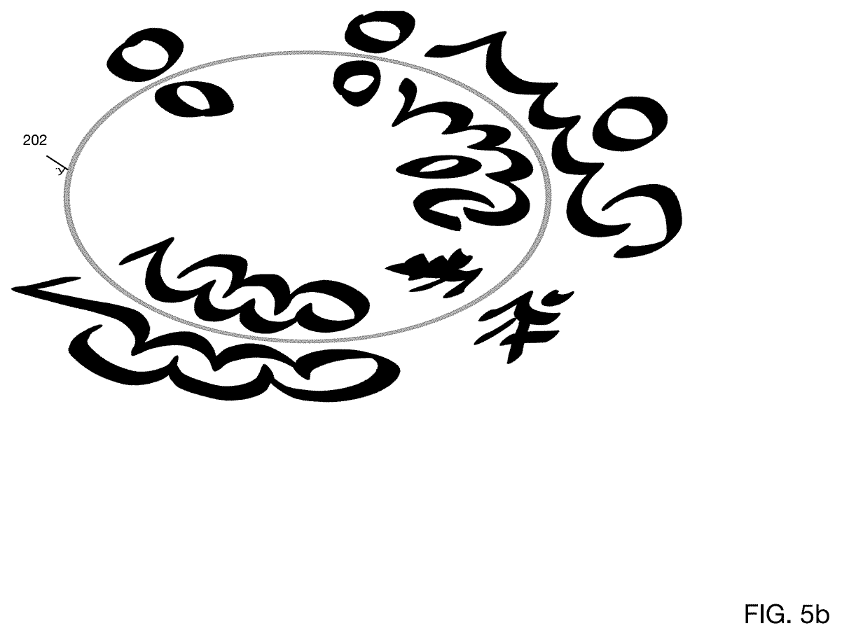

FIG. 5a shows an example of paint reflection using a curvilinear path according to one embodiment of the present disclosure.

FIG. 5b shows an example of paint reflection using a circular curvilinear path according to one embodiment of the present disclosure.

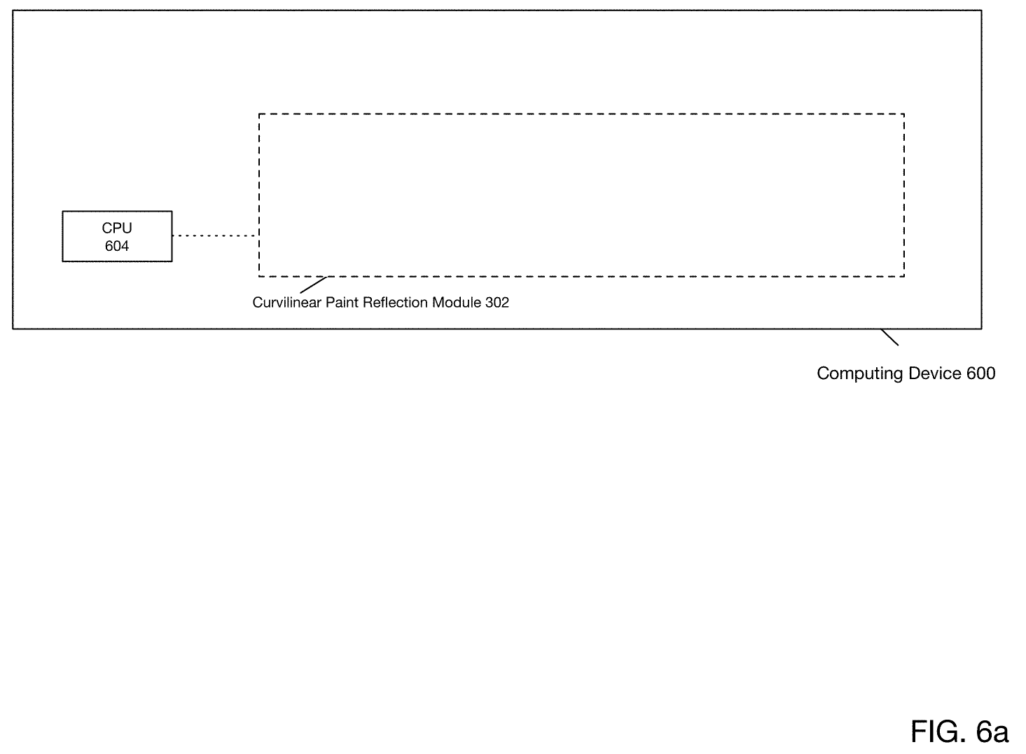

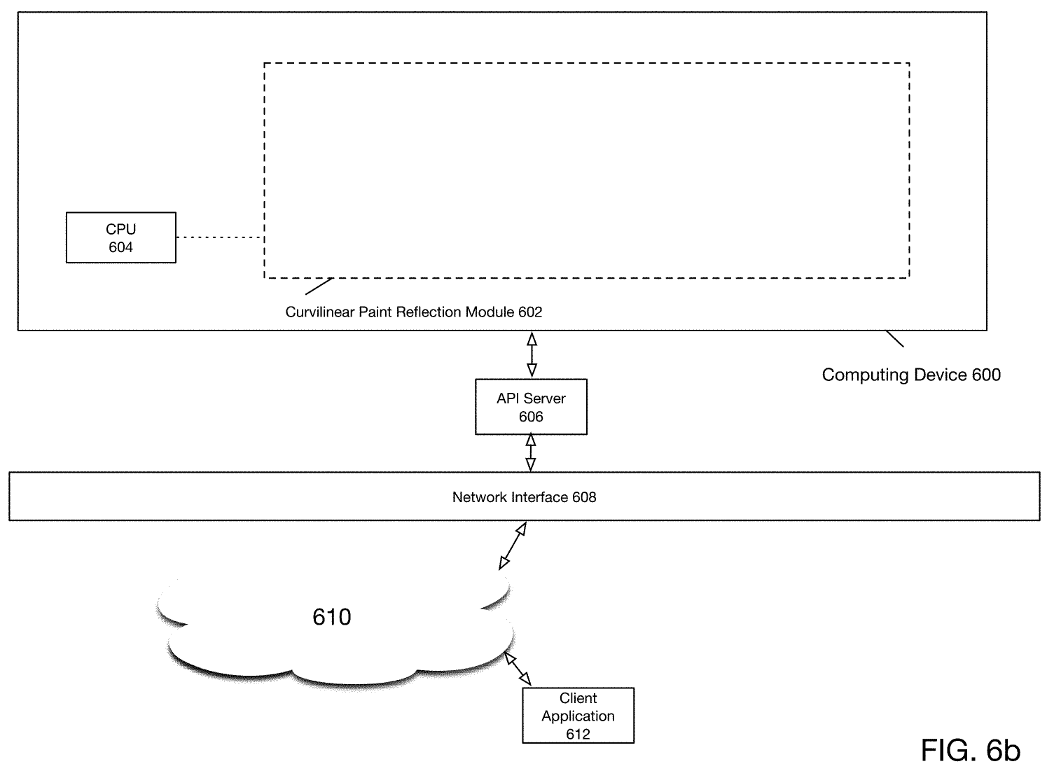

FIG. 6a illustrates an example computing system that executes an always strictly consistent multiple microservice coordination system according to one embodiment of the present disclosure. As depicted in FIG. 6a, computing device 600 may include CPU 604 that executes one or more processes to execute curvilinear paint reflection module 302. In particular, CPU 604 may be further configured via programmatic instructions to execute curvilinear paint reflection module 302 (as variously described herein). Other componentry and modules typical of a typical computing system, such as, for example a co-processor, a processing core, a graphics processing unit, a mouse, a touch pad, a touch screen, display, etc., are not shown but will be readily apparent. Numerous computing environment variations will be apparent in light of this disclosure. Computing device 600 can be any stand-alone computing platform, such as a desk top or work station computer, laptop computer, tablet computer, smart phone or personal digital assistant, game console, set-top box, or other suitable computing platform.

FIG. 6b illustrates an example integration of a curvilinear paint reflection module into a network environment according to one embodiment of the present disclosure. As depicted in FIG. 6b, computing device 600 may be collocated in a cloud environment, data center, local area network (“LAN”) etc. Computing device 600 shown in FIG. 6b is structured identically to the example embodiment described with respect to FIG. 6a. As shown in FIG. 6b, client application 612 may interact with computing device 600 via network 610. In particular, client application 612 may make requests and receive responses via API calls received at API server 606, which are transmitted via network 610 and network interface 608.

It will be understood that network 610 may comprise any type of public or private network including the Internet or LAN. It will be further readily understood that network 610 may comprise any type of public and/or private network including the Internet, LANs, WAN, or some combination of such networks. In this example case, computing device 600 is a server computer, and client application 612 may be any typical personal computing platform

As will be further appreciated, computing device 600, whether the one shown in FIG. 6a or 6b, includes and/or otherwise has access to one or more non-transitory computer-readable media or storage devices having encoded thereon one or more computer-executable instructions or software for implementing techniques as variously described in this disclosure. The storage devices may include any number of durable storage devices (e.g., any electronic, optical, and/or magnetic storage device, including RAM, ROM, Flash, USB drive, on-board CPU cache, hard-drive, server storage, magnetic tape, CD-ROM, or other physical computer readable storage media, for storing data and computer-readable instructions and/or software that implement various embodiments provided herein. Any combination of memories can be used, and the various storage components may be located in a single computing device or distributed across multiple computing devices. In addition, and as previously explained, the one or more storage devices may be provided separately or remotely from the one or more computing devices. Numerous configurations are possible.

In some example embodiments of the present disclosure, the various functional modules described herein and specifically training and/or testing of network 340, may be implemented in software, such as a set of instructions (e.g., HTML, XML, C, C++, object-oriented C, JavaScript, Java, BASIC, etc.) encoded on any non-transitory computer readable medium or computer program product (e.g., hard drive, server, disc, or other suitable non-transitory memory or set of memories), that when executed by one or more processors, cause the various creator recommendation methodologies provided herein to be carried out.

In still other embodiments, the techniques provided herein are implemented using software-based engines. In such embodiments, an engine is a functional unit including one or more processors programmed or otherwise configured with instructions encoding a creator recommendation process as variously provided herein. In this way, a software-based engine is a functional circuit.

In still other embodiments, the techniques provided herein are implemented with hardware circuits, such as gate level logic (FPGA) or a purpose-built semiconductor (e.g., application specific integrated circuit, or ASIC). Still other embodiments are implemented with a microcontroller having a processor, a number of input/output ports for receiving and outputting data, and a number of embedded routines by the processor for carrying out the functionality provided herein. In a more general sense, any suitable combination of hardware, software, and firmware can be used, as will be apparent. As used herein, a circuit is one or more physical components and is functional to carry out a task. For instance, a circuit may be one or more processors programmed or otherwise configured with a software module, or a logic-based hardware circuit that provides a set of outputs in response to a certain set of input stimuli. Numerous configurations will be apparent.

The foregoing description of example embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

### FURTHER EXAMPLE EMBODIMENTS

The following examples pertain to further embodiments, from which numerous permutations and configurations will be apparent.

Example 1 is a method for performing paint reflection of a plurality of sample points around a curvilinear path, the method comprising receiving a curvilinear path, wherein said curvilinear path comprises a plurality of points and separates a first region from a second region, for a sample point within said first region, determining an associated reflected point in said second region by determining a closest point on said curvilinear path contour, and, performing a linear paint reflection operation with respect to said sample point and said closest point to generate said associated reflected point.

Example 2 is the method of Example 1 wherein performing a linear paint reflection comprises computing a perpendicular from said sample point to said closest point, and, generating a reflected perpendicular from said perpendicular to generate said reflected point, wherein said reflected point comprises an endpoint of said reflected perpendicular.

Example 3 is the method of Example 2, wherein computing a perpendicular further comprises determining a tangent line at said closest point, and, determining said a perpendicular line to said tangent line.

Example 4 is the method according to Example 1, wherein said plurality of sample points and said curvilinear path are generated based on input received from a digital input device.

Example 5 is the method according to Example 1, wherein said curvilinear path is extended beyond an endpoint associated with such curvilinear path by concatenating a straight line at said endpoint, said straight line having a slope associated with a point near said endpoint.

Example 6 is the method according to Example 1, wherein said sample points lie in a 2D space.

Example 7 is the method according to Example 1, wherein said sample points lie in a 3D space.

Example 8 is a system for performing paint reflection of a plurality of sample points around a curvilinear path comprising a processor, wherein said processor is adapted to execute a curvilinear paint reflection process, said process further comprising receiving a curvilinear path, wherein said curvilinear path comprises a plurality of points and separates a first region from a second region for a sample point within said first region, determining an associated reflected point in said second region by determining a closest point on said curvilinear path contour, and, performing a linear paint reflection operation with respect to said sample point and said closest point to generate said associated reflected point.

Example 9 is the system of Example 8, wherein performing a linear paint reflection further comprises computing a perpendicular from said sample point to said closest point, and, generating a reflected perpendicular from said perpendicular to generate said reflected point, wherein said reflected point comprises an endpoint of said reflected perpendicular.

Example 10 is the system of Example 8, wherein said plurality of sample points and said curvilinear path are generated from a digital input device.

Example 11 is the system of Example 8, wherein said curvilinear path is extended beyond an endpoint associated with such curvilinear path by concatenating a straight line at said endpoint, said straight line having a slope associated with a point near said endpoint.

Example 12 is the system of Example 9, wherein computing a perpendicular further comprise determining a tangent line at said closest point, and, determining said a perpendicular line to said tangent line.

Example 13 is the system of Example 8, wherein said sample points lie in a 2D plane.

Example 14 is the system of Example 8, wherein said sample points lie in a 3D space.

Example 15 is a computer program product including one or more non-transitory machine-readable mediums encoded with instructions that when executed by one or more processors cause a process to be carried out for performing paint reflection of a plurality of sample points around a curvilinear path, the method comprising receiving a curvilinear path, wherein said curvilinear path comprises a plurality of points, and separates a first region from a second region, for a sample point within said first region, determining an associated reflected point in said second region by determining a closest point on said curvilinear path contour, and, performing a linear paint reflection operation with respect to said sample point and said closest point to generate said associated reflected point.

Example 16 is the computer program product of Example 15, wherein performing a linear paint reflection further comprises computing a perpendicular from said sample point to said closest point, and, generating a reflected perpendicular from said perpendicular to generate said reflected point, wherein said reflected point comprises an endpoint of said reflected perpendicular.

Example 17 is the computer program product according to Example 15, wherein said plurality of sample points and said curvilinear path are generated from a digital input device.

Example 18 is the computer program product of Example 15, wherein said curvilinear path is extended beyond an endpoint associated with such curvilinear path by concatenating a straight line at said endpoint, said straight line having a slope associated with a point near said endpoint.

Example 19 is the computer program product of Example 16, wherein generating a perpendicular further comprises determining a tangent line at said closest point, and, determining said a perpendicular line to said tangent line.

Example 20 is the computer program product of Example 15, wherein said sample points lie in a 2D plane.

What is claimed is:

1. A method for performing paint reflection of a plurality of sample points around a curvilinear path, the method comprising:
receiving a curvilinear path, wherein said curvilinear path comprises a plurality of points and separates a first region from a second region;
for a sample point within said first region, determining an associated reflected point in said second region by:
determining a closest point on said curvilinear path contour; and,
performing a linear paint reflection operation with respect to said sample point and said closest point to generate said associated reflected point.

2. The method according to claim 1, wherein performing a linear paint reflection comprises:
computing a perpendicular from said sample point to said closest point; and,
generating a reflected perpendicular from said perpendicular to generate said reflected point, wherein said reflected point comprises an endpoint of said reflected perpendicular.

3. The method according to claim 2, wherein computing a perpendicular further comprises:
determining a tangent line at said closest point; and,
determining said a perpendicular line to said tangent line.

4. The method according to claim 1, wherein said plurality of sample points and said curvilinear path are generated based on input received from a digital input device.

5. The method according to claim 1, wherein said curvilinear path is extended beyond an endpoint associated with such curvilinear path by concatenating a straight line at said endpoint, said straight line having a slope associated with a point near said endpoint.

6. The method according to claim 1, wherein said sample points lie in a 2D space.

7. The method according to claim 1, wherein said sample points lie in a 3D space.

8. A system for performing paint reflection of a plurality of sample points around a curvilinear path comprising:
a processor, wherein said processor is adapted to execute a curvilinear paint reflection process, said process further comprising:
receiving a curvilinear path, wherein said curvilinear path comprises a plurality of points and separates a first region from a second region;
for a sample point within said first region, determining an associated reflected point in said second region by:
determining a closest point on said curvilinear path contour; and,
performing a linear paint reflection operation with respect to said sample point and said closest point to generate said associated reflected point.

9. The system according to claim 8, wherein performing a linear paint reflection further comprises:
computing a perpendicular from said sample point to said closest point; and,
generating a reflected perpendicular from said perpendicular to generate said reflected point, wherein said reflected point comprises an endpoint of said reflected perpendicular.

10. The system according to claim 8, wherein said plurality of sample points and said curvilinear path are generated from a digital input device.

11. The system according to claim 8, wherein said curvilinear path is extended beyond an endpoint associated with such curvilinear path by concatenating a straight line at said endpoint, said straight line having a slope associated with a point near said endpoint.

12. The system according to claim 9, wherein computing a perpendicular further comprises:
determining a tangent line at said closest point; and,
determining said a perpendicular line to said tangent line.

13. The system according to claim 8, wherein said sample points lie in a 2D plane.

14. The system according to claim 8, wherein said sample points lie in a 3D space.

15. A computer program product including one or more non-transitory machine-readable mediums encoded with instructions that when executed by one or more processors cause a process to be carried out for performing paint reflection of a plurality of sample points around a curvilinear path, the method comprising:
receiving a curvilinear path, wherein said curvilinear path comprises a plurality of points, and separates a first region from a second region;
for a sample point within said first region, determining an associated reflected point in said second region by:
determining a closest point on said curvilinear path contour; and,
performing a linear paint reflection operation with respect to said sample point and said closest point to generate said associated reflected point.

16. The computer program product according to claim 15, wherein performing a linear paint reflection further comprises:
computing a perpendicular from said sample point to said closest point; and,
generating a reflected perpendicular from said perpendicular to generate said reflected point, wherein said reflected point comprises an endpoint of said reflected perpendicular.

17. The computer program product according to claim 15, wherein said plurality of sample points and said curvilinear path are generated from a digital input device.

18. The computer program product according to claim 15, wherein said curvilinear path is extended beyond an endpoint associated with such curvilinear path by concatenating a straight line at said endpoint, said straight line having a slope associated with a point near said endpoint.

19. The computer program product according to claim 16, wherein generating a perpendicular further comprises:
determining a tangent line at said closest point; and,
determining said a perpendicular line to said tangent line.

20. The computer program product according to claim 15, wherein said sample points lie in a 2D plane.
